(19) United States
(12) Patent Application Publication
(10) Pub. No.: US 2025/0122052 A1
(43) Pub. Date: Apr. 17, 2025

(54) CRANE, TRANSPORTATION METHOD, AND PLATE MEMBER MANUFACTURING METHOD

(71) Applicant: JFE Steel Corporation, Chiyoda-ku, Tokyo (JP)

(72) Inventors: Yuki TAKAKI, Tokyo (JP); Yusaku TAKEMURA, Tokyo (JP); Kento UEMATSU, Tokyo (JP); Atsushi KURIMOTO, Tokyo (JP); Ayaka USUI, Tokyo (JP)

(73) Assignee: JFE Steel Corporation, Chiyoda-ku, Tokyo (JP)

(21) Appl. No.: 18/833,998

(22) PCT Filed: Jan. 30, 2023
(86) PCT No.: PCT/JP2023/002890

§ 371 Date: Jul. 29, 2024

(30) Foreign Application Priority Data
Jan. 31, 2022 (JP) 2022-013063

(51) Int. Cl. B66C 13/46; B66C 13/22

(52) U.S. Cl. CPC B66C 13/46; B66C 13/22

(57) ABSTRACT

A crane, a transportation method, and a plate member manufacturing method are disclosed. There is provided a crane for performing handling and transportation of a plate member, and the crane includes: a holding mechanism configured to lift and hold the plate member; a drive mechanism configured to move the holding mechanism at least horizontally; an image acquisition mechanism configured to acquire an image of the plate member such that the image includes a feature portion of the plate member; and a control mechanism configured to detect the feature portion from the image, calculate a position of the plate member from a position of the feature portion, and adjust a horizontal position of the holding mechanism based on the position of the plate member.

### CROSS REFERENCE TO RELATED APPLICATIONS

This is the U.S. National Phase application of PCT/JP2023/002890, filed Jan. 30, 2023, which claims priority to Japanese Patent Application No. 2022-013063, filed Jan. 31, 2022, the disclosures of each of these applications being incorporated herein by reference in their entireties for all purposes.

### FIELD OF THE INVENTION

The present invention relates to a crane, a transportation method, and a plate member manufacturing method.

### BACKGROUND OF THE INVENTION

A plate mill factory at steel works includes rolling equipment (a rolling step) for rolling a lump-form steel sheet (an example of a plate member) into a desired thickness, finishing equipment (a finishing step) for performing cutting of the rolled steel sheet into a shipment size, deburring in end portions, repairing of defects on surfaces, inspecting of internal defects, and the like, and a product warehouse in which steel sheets to be shipped are stored. Steel sheets as products in process in the finishing equipment or the steel sheets to be shipped in the product warehouse are stored in such a state that several or more than a dozen steel sheets are stacked due to restriction of a storage space. At the time when the steel sheets are rearranged or shipped, one or several target steel sheets are lifted and moved by use of a crane to which an electromagnetic lifting magnet or the like is attached, for example.

When this operation is performed, it is necessary to accurately grasp the gravitational center position of the steel sheet. Particularly, in a case where a thick steel sheet having a plate thickness of 100 mm or more is lifted by use of a crane generally used in a plate mill factory at steel works, when the gravitational center of a steel sheet as a target to be lifted deviates from the center of the lifting magnet, there is such a risk that the steel sheet might be dropped due to an unbalanced load in the worst case. On this account, means for accurately grasping the gravitational center position of a steel sheet is required.

In order to solve such a problem, PTL 1 discloses a method for detecting the position of a steel sheet as a target to be lifted, for example. For example, PTL 1 proposes a method for obtaining the shapes and the gravitational center positions of stacked steel sheets by image processing to separately extract planar images and side images of the steel sheets from among images captured by a camera from diagonally above the steel sheets.

### PATENT LITERATURE

PTL 1: JP H7-330287 A

### SUMMARY OF THE INVENTION

The method in PTL 1 is a method in which the installation position of each steel sheet is calculated by separating the stacked steel sheets at stepped portions by detecting step shapes in the stacked steel sheets by image processing. However, in a situation where a plurality of thin steel sheets having a plate thickness of around 10 mm or less is stacked, upper and lower steel sheets are detected in an integrated manner, and therefore, it is difficult to detect only the position of an uppermost steel sheet as a target to be lifted.

Aspects of the present invention are accomplished in view of the above problem, and an object according to aspects of the present invention is to provide a crane, a transportation method, and a plate member manufacturing method each of which can accurately detect the position of a plate member as a target to be lifted.
(1) One aspect of the present invention provides a crane for performing handling and transportation of a plate member. The crane includes: a holding mechanism configured to lift and hold the plate member; a drive mechanism configured to move the holding mechanism at least horizontally; an image acquisition mechanism configured to acquire an image of the plate member such that the image includes a feature portion of the plate member; and a control mechanism configured to detect the feature portion from the image, calculate a position of the plate member from a position of the feature portion, and adjust a horizontal position of the holding mechanism based on the position of the plate member.
(2) In the crane described in (1), the feature portion is a marking provided at a predetermined position on the plate member, and the control mechanism calculates a gravitational center position of the plate member as the position of the plate member from a dimension of the plate member and a position of the marking.
(3) The crane described in (1) or (2) further includes a self-position detecting mechanism configured to detect a horizontal central position of the holding mechanism, and the control mechanism gives a drive command to the drive mechanism such that a distance between a gravitational center position of the plate member and the central position of the holding mechanism is equal to or less than a threshold.
(4) The crane described in any one of (1) to (3) further includes a traveling rail provided on a ceiling of a building where the plate member is stored. The drive mechanism to which the holding mechanism is attached is moved along the traveling rail such that the holding mechanism is moved horizontally.
(5) In the crane described in (4), the image acquisition mechanism is attached to the drive mechanism.
(6) One aspect of the present invention provides a transportation method for performing handling and transportation of a plate member. The transportation method includes: acquiring an image of the plate member such that the image includes a feature portion of the plate member; detecting the feature portion from the image and calculating a position of the plate member from a position of the feature portion; adjusting a horizontal position of a holding mechanism based on the position of the plate member, the holding mechanism being configured to lift and hold the plate member; and lifting and transporting the plate member after the horizontal position of the holding mechanism is adjusted.
(7) One aspect of the present invention provides a plate member manufacturing method for performing handling and transportation of the plate member by use of the crane according to any one of (1) to (5) in a manufacturing step of manufacturing the plate member.

With one aspect of the present invention, it is possible to provide a crane, a transportation method, and a plate member manufacturing method each of which can accurately detect the position of a plate member as a target to be lifted.

### BRIEF DESCRIPTION OF THE DRAWINGS

FIG. 1 is a schematic view illustrating a crane according to one embodiment of the present invention;

FIG. 2 is an explanatory view illustrating the relationship between constituent members of the crane;

FIG. 3 is a configuration diagram of a control mechanism;

FIG. 4 is an explanatory view illustrating the positional relationship between a plate member and a marking;

FIG. 5 is a processing flow diagram illustrating a handling and transportation method;

FIG. 6 is a plan view illustrating an installation state of steel sheets having a plate thickness t20 in Example; and

FIG. 7 is a plan view illustrating an installation state of steel sheets having respective plate thicknesses t5, t10, t20 in Example.

### DETAILED DESCRIPTION OF EMBODIMENTS OF THE INVENTION

With reference to the drawings, the following detailed description deals with embodiments of the present invention. In the following description, identical or similar constituents have identical or similar reference signs, and redundant descriptions are omitted. Each drawing is schematic and includes a case different from actual ones. Each embodiment described below describes a device or a method to embody the technical idea according to aspects of the present invention, and the technical idea according to aspects of the present invention does not specify a material, a structure, an arrangement, and the like of a component part to those described below. Various changes can be added to the technical idea according to aspects of the present invention within a technical scope defined by claims described in Claims.

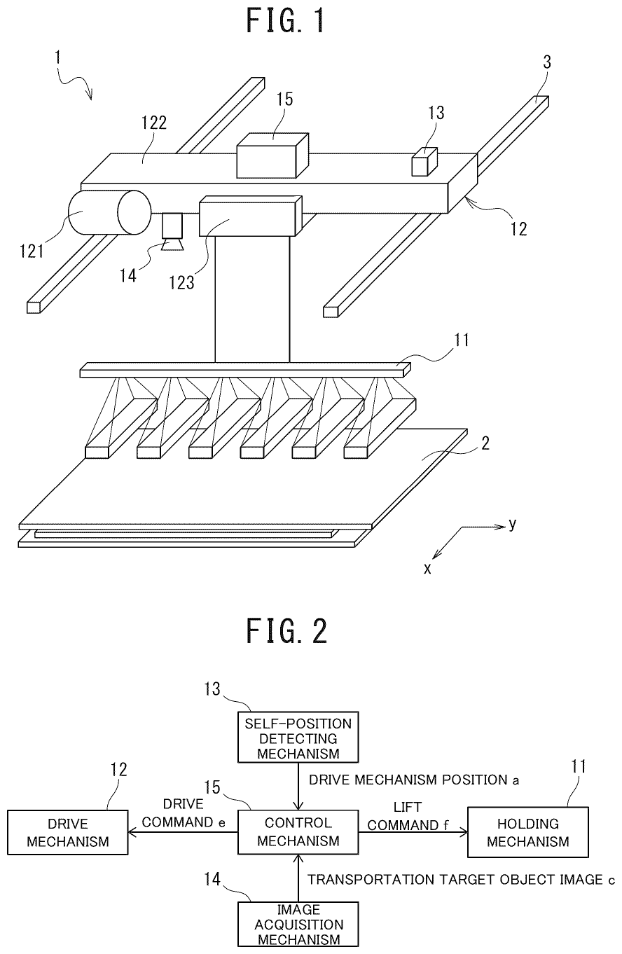

FIG. 1 schematically illustrates a crane 1 according to one embodiment of the present invention. In addition, FIG. 2 is a schematic view illustrating the relationship between constituent members of the crane 1. The crane 1 is an overhead crane configured to lift and transport a plate member 2. In the present embodiment, the plate member 2 is a steel sheet, and the crane 1 transports the plate member 2 stored in a building. In addition, in this building, a traveling rail 3 on which the crane 1 moves is provided on a ceiling. Note that the crane 1 may be defined to include the traveling rail 3. The crane 1 includes a holding mechanism 11, a drive mechanism 12, a self-position detecting mechanism 13, an image acquisition mechanism 14, and a control mechanism 15.

The holding mechanism 11 is a mechanism configured to lift the plate member 2 as a target to be lifted in response to a lift command f from the control mechanism 15, and in the present embodiment, the holding mechanism 11 is an electromagnetic lifting magnet as one example. It is preferable that the holding mechanism 11 be an electromagnetic lifting magnet, but the holding mechanism 11 may be a permanent-magnet lifting magnet, a cramp, or the like.

The drive mechanism 12 is a mechanism configured to move the holding mechanism 11 in response to a drive command e from the control mechanism 15, and in the present embodiment, the drive mechanism 12 includes a traveling trestle 121, a crane garter 122, and a hoist 123. The crane garter 122 is attached to the traveling rail 3 via the traveling trestle 121. That is, the crane 1 is configured to be movable in one axis direction (a horizontal first-axis direction) parallel to the horizontal direction when the drive mechanism 12 moves along the traveling rail 3. The hoist 123 is configured to be movable on the crane garter 122 in one axis direction (a horizontal second-axis direction) parallel to the horizontal direction and perpendicular to the moving direction of the crane 1. In addition, the holding mechanism 11 is hung and fixed to the crane garter 122 via the hoist 123. The hoist 123 hoists or lowers the holding mechanism 11 so that the holding mechanism 11 can be moved in the vertical direction.

The self-position detecting mechanism 13 is a mechanism configured to detect plane position coordinates (a horizontal position) of the drive mechanism 12 and is, for example, a laser range finder. In the example illustrated in FIG. 1, the self-position detecting mechanism 13 is a laser range finder provided in the crane garter 122 and is configured to detect the plane position of the drive mechanism 12 by measuring a distance to wall surfaces in two directions, for example. The self-position detecting mechanism 13 may be other mechanisms such as an outdoor GPS, an indoor GPS, or a beacon, for example, and may be provided on the ground or the like, which is other than the crane garter 122, provided that the self-position detecting mechanism 13 can detect the position of the drive mechanism 12. The plane position coordinates of the drive mechanism 12, acquired by the self-position detecting mechanism 13, are also called a drive mechanism position a, and the drive mechanism position a is sent to the control mechanism 15.

The image acquisition mechanism 14 is a camera or the like provided in the crane garter 122 and is configured to capture an image of the ground from above in the vertical direction. The image acquisition mechanism 14 acquires an image of the plate member 2 such that the image includes a feature portion of the plate member 2. The image acquisition mechanism 14 is preferably a camera configured to capture a still image but may be a video camera for recording a moving image, an infrared camera, or the like. In addition, it is preferable that the image acquisition mechanism 14 be able to acquire a high-resolution image to such an extent that the feature portion of the plate member 2 put on the ground is identifiable. In the present embodiment, the feature portion of the plate member 2 is a marking of a product number or the like provided at a predetermined position on the plate member 2. For example, the image acquisition mechanism 14 may be a camera (a 4K-camera) that can acquire an image of 4K-size resolution. Furthermore, the image acquisition mechanism 14 may be provided on the ground or the like, which is other than the crane garter 122, for example. The image acquired by the image acquisition mechanism 14 is also called a transportation target object image c, and the transportation target object image c is sent to the control mechanism 15.

The control mechanism 15 is a mechanism configured to adjust the position of the holding mechanism 11 by controlling the drive mechanism 12. It is preferable that the control mechanism 15 be a PLC (Programmable Logic Controller), but the control mechanism 15 may be a PC or the like. In addition, the control mechanism 15 finds a driving amount of the crane 1 based on the drive mechanism position a acquired by the self-position detecting mechanism 13 and the transportation target object image c acquired by the image acquisition mechanism 14 and controls the drive mechanism 12 and the holding mechanism 11 such that the plate member 2 is lifted. The control mechanism 15 may be provided in the crane garter 122 or may be provided on the ground or the like, which is other than the crane garter 122, for example.

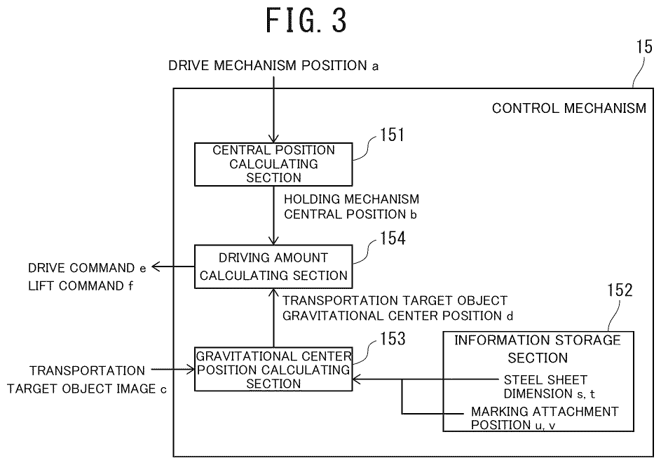

More specifically, as illustrated in FIG. 2, the control mechanism 15 acquires the drive mechanism position a and the transportation target object image c from the self-position detecting mechanism 13 and the image acquisition mechanism 14, respectively, and outputs the drive command e and the lift command f to the drive mechanism 12 and the holding mechanism 11, respectively. As illustrated in FIG. 3, the control mechanism 15 includes a central position calculating section 151, an information storage section 152, a gravitational center position calculating section 153, and a driving amount calculating section 154.

The central position calculating section 151 calculates the central position (a holding mechanism central position b) of the holding mechanism 11 from the drive mechanism position a. The calculated holding mechanism central position b is sent to the driving amount calculating section 154. The holding mechanism central position b is set as coordinates (x_{c}, y_{c}) in an x-axis direction and a y-axis direction parallel to the horizontal direction and perpendicular to each other.

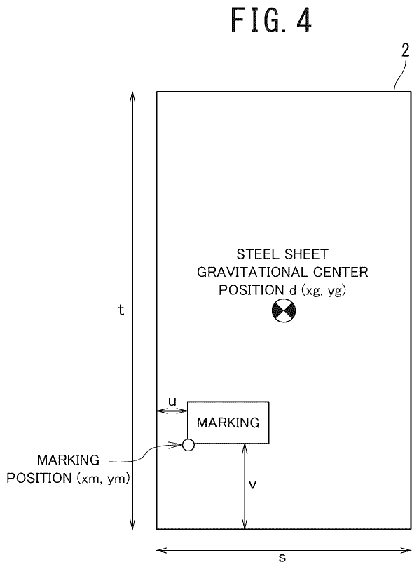

The information storage section 152 records at least a dimension (s, t) and a marking attachment position (u, v) of the plate member 2 as information on the plate member 2. The dimension (s, t) includes longitudinal and lateral lengths of the plate member 2 such as a steel sheet and indicates, for example, a length s and a length t of the plate member 2 illustrated in FIG. 4. The marking is a product number or the like attached to the plate member 2. In a case where the plate member 2 is a steel sheet, a product number or the like is printed as the marking at a predetermined position (a corner) on the surface of the steel sheet by use of a stencil and a blowing material. The printing position of the product number or the like is determined in accordance with the steel plate labeling standard (JSSKX-71-0000 (2020)), for example. The marking attachment position (u, v) is the attachment position of the marking attached to the plate member 2 and indicates a length u and a length v of the plate member 2 illustrated in FIG. 4, for example. The length u is a distance of the marking from a left end of the plate member 2 in FIG. 4, and the length v is a distance of the marking from a lower end of the plate member 2 in FIG. 4.

The gravitational center position calculating section 153 calculates a marking position from the transportation target object image c. In addition, the gravitational center position calculating section 153 calculates a transportation target object gravitational center position d, which is the gravitational center position of the plate member 2 as a transportation target object, from the dimension (s, t) and the marking attachment position (u, v) acquired from the information storage section 152, and the marking position. The marking position and the transportation target object gravitational center position d are set as coordinates (xₘ, yₘ) and coordinates (x_{g}, y_{g}) in the x-axis direction and the y-axis direction, respectively. Details of a calculation method of the marking position and the transportation target object gravitational center position d will be described later.

The driving amount calculating section 154 calculates the driving amount of the crane 1, that is, the drive command e and the lift command f by use of the holding mechanism central position b and the transportation target object gravitational center position d acquired from the central position calculating section 151 and the gravitational center position calculating section 153, respectively. Details of a calculation method of the driving amount will be described later.

### (Handling and Transportation Method and Plate Member Manufacturing Method)

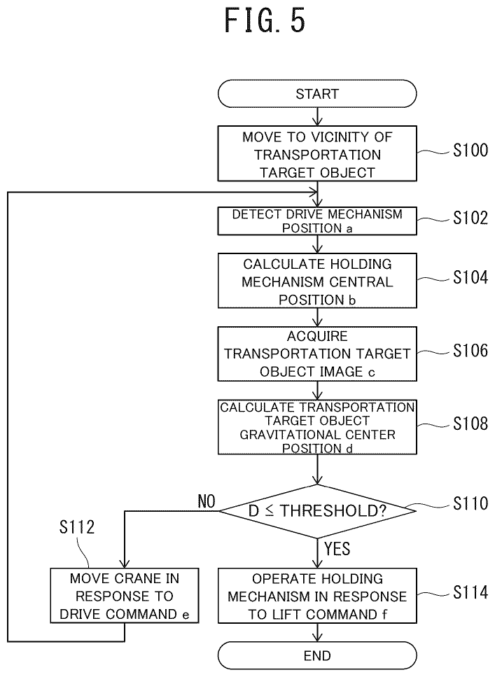

The handling and transportation method of the plate member 2 according to the present embodiment is performed in accordance with a processing flow of automatic traveling illustrated in FIG. 5. In the process illustrated in FIG. 5, the crane 1 automatically travels and lifts the plate member 2 stored in the building. The plate member 2 is placed at a determined storage position in the building. In addition, the plate member 2 as a transportation target object may be put on other plate members 2, and in this case, the plate member 2 as the transportation target object is placed on the uppermost portion among a plurality of stacked plate members 2. In the building, a plurality of storage positions is set, and each storage position is configured such that one plate member 2 or a plurality of stacked plate members 2 is storable therein.

First, the crane 1 moves to the vicinity of the plate member 2 as the transportation target object (S100). In step S100, the crane 1 moves to a place within a range where the image acquisition mechanism 14 can capture an image of the plate member 2. At this time, it is preferable that the crane 1 move by use of positional information on a section where the plate member 2 is placed (for example, steel sheet piles or the like in a case where the plate member 2 is a steel sheet). However, the crane 1 may move upon receipt of positional information given thereto by other means.

Then, the self-position detecting mechanism 13 detects the drive mechanism position a (S102). The detected drive mechanism position a is sent to the central position calculating section 151.

Further, the central position calculating section 151 calculates the holding mechanism central position b as the central position of the holding mechanism 11 on plane coordinates from the acquired drive mechanism position a (S104). A calculation method of the holding mechanism central position b by use of the drive mechanism position a is not particularly limited. For example, in a case where a relative plane position of the holding mechanism central position b relative to the drive mechanism position a is determined in advance, the holding mechanism central position b may be calculated by correcting the drive mechanism position a based on such a relative plane position.

Then, the image acquisition mechanism 14 captures an image including the plate member 2 as the transportation target object to acquire the transportation target object image c (S106). The transportation target object image c does not necessarily need to include the whole plate member 2 as the transportation target object, provided that the transportation target object image includes a feature portion such as a marking on the plate member 2 as the transportation target object.

Subsequently, the gravitational center position calculating section 153 calculates the transportation target object gravitational center position d on the plane coordinates of the plate member 2 as the transportation target object from the acquired transportation target object image c (S108). In step S108, first, the gravitational center position calculating section 153 detects the marking on the plate member 2 as the transportation target object by image analysis or the like from the transportation target object image c and acquires a marking position (xₘ, yₘ) indicative of position coordinates of a left lower end of the marking. At this time, the position coordinates of the left lower end of the marking captured can be found by use of the drive mechanism position a and the holding mechanism central position b based on a relative positional relationship between a preset image capture position of the image acquisition mechanism 14 and the drive mechanism 12 or the holding mechanism 11. A method for detecting the marking is preferably performed such that learning data is prepared in advance from a captured image of the marking by use of R-CNN and an object is detected by use of the learning data. In addition, the learning data may be made by use of CNN, YOLO, or the like. Subsequently, the transportation target object gravitational center position d (x_{g}, y_{g}) of the plate member 2 is calculated based on the marking position (xₘ, yₘ), and the dimension (s, t) and the marking attachment position (u, v) of the plate member 2 as the transportation target object, the dimension (s, t) and the marking attachment position (u, v) being stored in the information storage section 152. The calculation of the gravitational center position can be performed by use of Formula (1) and Formula (2) described below.

$$\begin{matrix}[ Math . 1 ] & \\ {x}_{g} = {x}_{m} + \frac{s}{2} - u & ( 1 )\end{matrix}$$

$${y}_{g} = {y}_{m} + \frac{t}{2} - v \qquad ( 2 )$$

After step S108, the driving amount calculating section 154 determines whether or not a horizontal distance D between the holding mechanism central position b and the transportation target object gravitational center position d is equal to or less than a threshold (S110). The distance D may be a horizontal linear distance between the holding mechanism central position b and the transportation target object gravitational center position d or may be distances in the x-axis direction and in the y-axis direction between the holding mechanism central position b and the transportation target object gravitational center position d. It is preferable that the threshold be around 50 mm, although it depends on the dimension of the plate member 2 as the transportation target object. When the distance D falls within 50 mm, the plate member 2 can be lifted stably.

In a case where the horizontal distance between the holding mechanism central position b and the transportation target object gravitational center position d is larger than the threshold in the determination in step S110, the driving amount calculating section 154 determines that position adjustment of the crane 1 is required, and the driving amount calculating section 154 calculates a driving amount and outputs the drive command e to the drive mechanism 12 (S112). At this time, the driving amount calculating section 154 calculates a moving amount to move the holding mechanism central position b to the transportation target object gravitational center position d. Then, the driving amount calculating section 154 outputs the drive command e so that the holding mechanism 11 moves only by the moving amount. The drive mechanism 12 receives the drive command e and moves the holding mechanism 11. After step S112, the processes of step S102 and its subsequent steps are performed again.

In the meantime, in a case where the horizontal distance between the holding mechanism central position b and the transportation target object gravitational center position d is equal to or less than the threshold in the determination in step S110, the driving amount calculating section 154 determines that position adjustment of the crane 1 is finished, and the driving amount calculating section 154 outputs the lift command f to the holding mechanism 11 (S114). The holding mechanism 11 receives the lift command f and lifts the plate member 2.

When step S114 is finished, a lifting process of the plate member 2, illustrated in FIG. 5, is finished. After the lifting process of the plate member 2, illustrated in FIG. 5, is finished, the crane 1 transports the plate member 2 thus lifted to a given place. In addition, in the manufacturing method of the plate member 2 according to the present embodiment, handling and transportation of the plate member 2 is performed by use of the handling and transportation method according to the present embodiment in a manufacturing step of manufacturing the plate member 2.

With the crane 1, the handling and transportation method, and the plate member manufacturing method according to the present embodiment, it is possible to accurately detect the position of the plate member 2 as a target to be lifted, by reading a feature portion such as the marking on the plate member 2 at the time when the plate member 2 such as a steel sheet is lifted by the crane 1. Particularly, in the case of a crane using a conventional image recognition technology, it is difficult to detect an uppermost plate member from among a plurality of stacked plate members having a thin plate thickness. However, with the present embodiment, it is possible to detect the position of the uppermost plate member 2 regardless of the plate thickness. On this account, it is possible to achieve labor-saving and promote efficiency in the transportation operation of transporting the plate member 2.

### Modifications

Aspects of the present invention have been described with reference to a particular embodiment, but this is not intended to limit the invention by these descriptions. Other embodiments of the present invention including various modifications are also apparent to those skilled in the art as well as the embodiment disclosed herein by referring to the description of aspects of the present invention. In view of this, it should be understood that the embodiment of the invention described in claims also covers an embodiment including those modifications described herein solely or in combination.

For example, in the above embodiment, the crane 1 is an overhead crane, but the present invention is not limited to such an example. For example, the crane 1 is preferably an overhead crane attached to the ceiling but may be a jib-crane, a portal crane, or the like.

In addition, the crane 1 may lift a plurality of stacked plate members 2 at the same time. In this case, the crane 1 may lift the plurality of stacked plate members 2 by use of the marking on the uppermost plate member 2, in a similar manner to the above embodiment.

Further, in the above embodiment, the feature portion of the plate member 2 is a marking such as a product number, but the present invention is not limited to such an example. The feature portion of the plate member 2 may be other feature portions, provided that the feature portions are attached to a particular position on the plate member 2 and identifiable from the transportation target object image c. For example, the feature portion of the plate member 2 may be a mark printed for automatic transportation by the crane 1 or QR Code (registered trademark) or the like attached by a sticker. In a case where QR Code is used, information (the dimension or the like) on the plate member 2, stored in the QR Code, can be read. Further, other feature portions such as a pattern on the surface of the steel sheet, for example, may be used. Note that, in a case where the plate member 2 is a steel sheet, it is preferable to use a marking of a product number the printing position of which is known, in consideration of time and effort to newly put a marking on the plate member 2.

Further, in the above embodiment, the plate member 2 is a steel sheet, but the present invention is not limited to such an example. The plate member 2 may be made of other materials or have other dimensions and shapes, provided that the plate member 2 has a plate shape to be lifted and transported by a crane.

### EXAMPLES

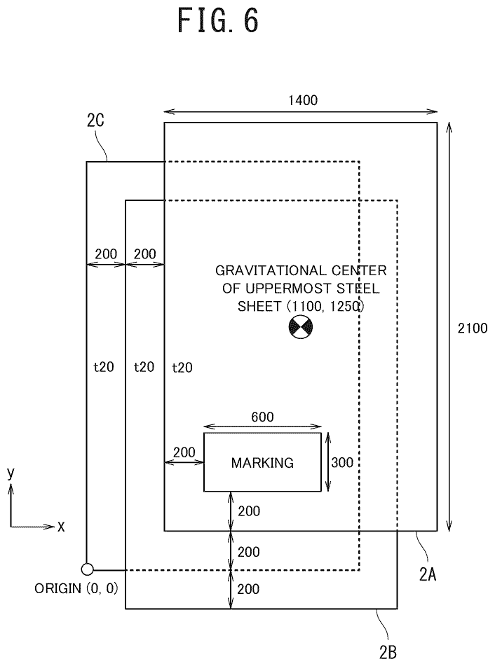

The following tests were performed as Example to evaluate the controllability of the number of sheets to be hung in accordance with aspects of the present invention. In Example, the crane 1 was moved in accordance with the procedure of [1] to [9] described below, and the holding mechanism central position b of the crane 1 after completion of the movement was measured and examined.
[1] Fifty images of a marking on a steel sheet as the plate member 2, captured from a distance of 1 m, were prepared, and learning data for marking detection was formed by an R-CNN method by use of the fifty images.
[2] Steel sheets having a width of 1400 mm, a height of 2100 mm, and a plate thickness t20 were prepared such that three steel sheets were stacked at a position illustrated in FIG. 6.
[3] A marking (with a product number or the like described with numeric characters and English letters) having a size of 600 mm in width and 300 mm in height was provided by a stencil and a blowing material such that the position of a lower left end of the marking was (600, 400) as illustrated in FIG. 6.
[4] A 4K-camera (the image acquisition mechanism 14) with about 10 million pixels (3648×2736) and a laser range finder (the self-position detecting mechanism 13) were attached to the crane 1 as an overhead crane traveling 10 m above the steel sheet, and the initial position of the crane 1 was adjusted such that the image acquisition mechanism 14 was right above an origin illustrated in FIG. 6.
[5] A marking position was detected by use of the learning data, based on the images captured by the image acquisition mechanism 14.
[6] The transportation target object gravitational center position of an uppermost steel sheet was calculated based on the marking position thus detected and a steel sheet dimension and a marking attachment position stored in the information storage section 152.
[7] The crane was moved transversely only by a value of (the transportation target object gravitational center position of the uppermost steel sheet)−(the central position of the holding mechanism 11 attached to the crane 1).
[8] The central position of the holding mechanism 11 attached to the crane 1 was measured by the laser range finder, and [6] and [7] were performed repeatedly until the value of (the transportation target object gravitational center position of the uppermost steel sheet)−(the central position of the holding mechanism 11 attached to the crane 1) was within ±20 mm.
[9] When the above steps were finished, the central position of the holding mechanism 11 attached to the crane 1 was measured by a total station.

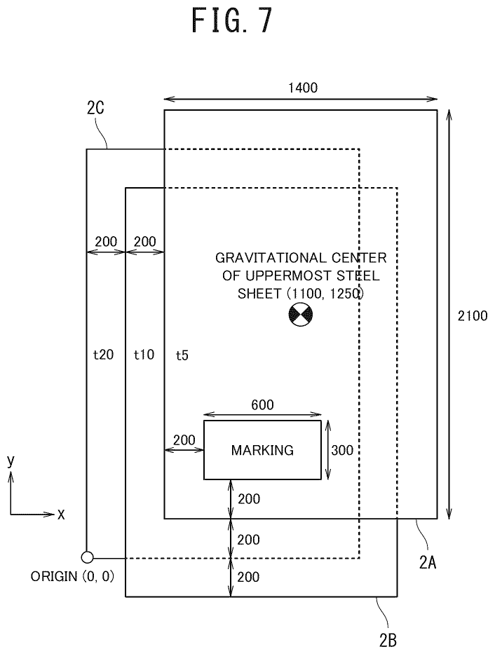

Results of Example are illustrated in Table 1. The central position of the holding mechanism 11 could be moved generally accurately to the transportation target object gravitational center position of the uppermost steel sheet as a target position. Further, as illustrated in FIG. 7, results obtained by performing the test in a similar manner with respective plate thicknesses of three steel sheets being changed to t5, t10, t20 from above are illustrated in Table 2. Even under this condition, generally the same results were obtained, and hereby, it can be found that the gravitational center positions of thin steel sheets having a plate thickness of 10 mm or less are also detectable, so that the steel sheets can be targets to be lifted by an automatic transportation crane.

TABLE 1
UNIT [mm]

CENTRAL POSITION
OF HOLDING MECHANISM

| | x | y |
|---|---|---|
| TARGET VALUE | 1100 | 1250 |
| EXAMPLE | 1086 | 1257 |
| DIFFERENCE | −14 | +7 |

TABLE 2
UNIT [mm]

CENTRAL POSITION
OF HOLDING MECHANISM

| | x | y |
|---|---|---|
| TARGET VALUE | 1100 | 1250 |
| EXAMPLE | 1083 | 1248 |
| DIFFERENCE | −17 | −2 |

Further, as a comparative example, a case where an overhead crane for lifting of the plate member 2 was moved by use of a conventional method was also examined. In the comparative example, the transportation target object gravitational center position of an uppermost steel sheet was calculated by a method in which a picture was taken by the same 4k-camera as in Example from an angle of 45° (from a position 7 m above the uppermost steel sheet and distanced therefrom by 7 m in the y-axis direction) and subjected to image processing to detect an end portion of the steel sheet, and the crane was moved transversely based on the information.

In the comparative example, results obtained under the condition that three sheets having a plate thickness t20 as illustrated in FIG. 6 are illustrated in Table 3. Under this condition, each steel sheet could be detected separately, and it was confirmed that the central position of the holding mechanism could be moved generally accurately to the transportation target object gravitational center position of the uppermost steel sheet as a target position.

TABLE 3

| UNIT [mm] | |
|---|---|
| | CENTRAL POSITION |
| | OF HOLDING MECHANISM |

| | x | y |
|---|---|---|
| TARGET VALUE | 1100 | 1250 |
| COMPARATIVE EXAMPLE | 1115 | 1233 |
| DIFFERENCE | +15 | −17 |

In the meantime, in the comparative example, results obtained under the condition that respective plate thicknesses of the steel sheets were changed to t5, t10, t20 from above as illustrated in FIG. 7 are illustrated in Table 4. Under this condition, the steel sheet of t5 and the steel sheet of t10 could not be separated from each other as different steel sheets, and they were detected as one steel sheet. As a result, a value deviating by about 100 mm in the x-direction and about 200 mm in the y-direction was detected as the transportation target object gravitational center position, and along with this, the central position of the holding mechanism deviated from the target position. From this result, it is found that, with this method, the position of the gravitational center of a thin steel sheet plate having a thickness of 10 mm or less could not be detected accurately, so that the thin steel plate cannot be a target for an automatic transportation crane.

TABLE 4

| UNIT [mm] | |
|---|---|
| | CENTRAL POSITION |
| | OF HOLDING MECHANISM |

| | x | y |
|---|---|---|
| TARGET VALUE | 1100 | 1250 |
| COMPARATIVE EXAMPLE | 989 | 1068 |
| DIFFERENCE | −111 | −182 |

### REFERENCE SIGNS LIST

1 crane
11 holding mechanism
12 drive mechanism
121 traveling trestle
122 crane garter
123 hoist
13 self-position detecting mechanism
14 image acquisition mechanism
15 control mechanism
151 central position calculating section
152 information storage section
153 gravitational center position calculating section
154 driving amount calculating section
2 plate member
3 traveling rail
a drive mechanism position
b holding mechanism central position
C transportation target object image
d transportation target object gravitational center position
e drive command

1. A crane for performing handling and transportation of a plate member, the crane comprising:
a holding mechanism configured to lift and hold the plate member;
a drive mechanism configured to move the holding mechanism at least horizontally;
an image acquisition mechanism configured to acquire an image of the plate member such that the image includes a feature portion of the plate member; and
a control mechanism configured to detect the feature portion from the image, calculate a position of the plate member from a position of the feature portion, and adjust a horizontal position of the holding mechanism based on the position of the plate member.

2. The crane according to claim 1, wherein:
the feature portion is a marking provided at a predetermined position on the plate member; and
the control mechanism calculates a gravitational center position of the plate member as the position of the plate member from a dimension of the plate member and a position of the marking.

3. The crane according to claim 1, further comprising:
a self-position detecting mechanism configured to detect a horizontal central position of the holding mechanism, wherein
the control mechanism gives a drive command to the drive mechanism such that a distance between a gravitational center position of the plate member and the central position of the holding mechanism is equal to or less than a threshold.

4. The crane according to claim 1, further comprising:
a traveling rail provided on a ceiling of a building where the plate member is stored, wherein
the drive mechanism to which the holding mechanism is attached is moved along the traveling rail such that the holding mechanism is moved horizontally.

5. The crane according to claim 4, wherein
the image acquisition mechanism is attached to the drive mechanism.

6. A transportation method for performing handling and transportation of a plate member, the transportation method comprising:
acquiring an image of the plate member such that the image includes a feature portion of the plate member;
detecting the feature portion from the image and calculating a position of the plate member from a position of the feature portion;
adjusting a horizontal position of a holding mechanism based on the position of the plate member, the holding mechanism being configured to lift and hold the plate member; and
lifting and transporting the plate member after the horizontal position of the holding mechanism is adjusted.

7. A plate member manufacturing method for performing handling and transportation of the plate member by use of the crane according to claim 1 in a manufacturing step of manufacturing the plate member.

8. The crane according to claim 2, further comprising:
a self-position detecting mechanism configured to detect a horizontal central position of the holding mechanism, wherein
the control mechanism gives a drive command to the drive mechanism such that a distance between a gravitational center position of the plate member and the central position of the holding mechanism is equal to or less than a threshold.

9. The crane according to claim 2, further comprising:
a traveling rail provided on a ceiling of a building where the plate member is stored, wherein
the drive mechanism to which the holding mechanism is attached is moved along the traveling rail such that the holding mechanism is moved horizontally.

10. The crane according to claim 3, further comprising:
a traveling rail provided on a ceiling of a building where the plate member is stored, wherein
the drive mechanism to which the holding mechanism is attached is moved along the traveling rail such that the holding mechanism is moved horizontally.

11. The crane according to claim 8, further comprising:
a traveling rail provided on a ceiling of a building where the plate member is stored, wherein
the drive mechanism to which the holding mechanism is attached is moved along the traveling rail such that the holding mechanism is moved horizontally.

12. The crane according to claim 9, wherein
the image acquisition mechanism is attached to the drive mechanism.

13. The crane according to claim 10, wherein
the image acquisition mechanism is attached to the drive mechanism.

14. The crane according to claim 11, wherein
the image acquisition mechanism is attached to the drive mechanism.

15. A plate member manufacturing method for performing handling and transportation of the plate member by use of the crane according to claim 2 in a manufacturing step of manufacturing the plate member.

16. A plate member manufacturing method for performing handling and transportation of the plate member by use of the crane according to claim 3 in a manufacturing step of manufacturing the plate member.

17. A plate member manufacturing method for performing handling and transportation of the plate member by use of the crane according to claim 4 in a manufacturing step of manufacturing the plate member.

18. A plate member manufacturing method for performing handling and transportation of the plate member by use of the crane according to claim 5 in a manufacturing step of manufacturing the plate member.

19. A plate member manufacturing method for performing handling and transportation of the plate member by use of the crane according to claim 8 in a manufacturing step of manufacturing the plate member.

20. A plate member manufacturing method for performing handling and transportation of the plate member by use of the crane according to claim 9 in a manufacturing step of manufacturing the plate member.
